(19) United States
(12) Patent Application Publication
(10) Pub. No.: US 2014/0123035 A1
(43) Pub. Date: May 1, 2014

(54) Method, terminal, server and computer readable medium for displaying microblog topic

(71) Applicant: TENCENT TECHNOLOGY (SHENZHEN) COMPANY LIMITED, SHENZHEN (CN)

(72) Inventors: Nian Liu, Shenzhen (CN); Qunli Ma, Shenzhen (CN); Wei Wu, Shenzhen (CN); Huaheng Fan, Shenzhen (CN); Chuan Peng, Shenzhen (CN); Jun Zhang, Shenzhen (CN); Ziming Wang, Shenzhen (CN); Yang Li, Shenzhen (CN)

(21) Appl. No.: 14/147,934

(22) Filed: Jan. 6, 2014

Related U.S. Application Data
(63) Continuation of application No. PCT/CN2013/073735, filed on Apr. 3, 2013.

(30) Foreign Application Priority Data
Apr. 26, 2012 (CN) 2012101268634

(51) Int. Cl. H04L 29/06; G06F 3/0484

(52) U.S. Cl. CPC H04L 65/403; G06F 3/0484
USPC 715/753

(57) ABSTRACT

The present disclosure discloses a method and system for displaying a microblog topic, a UE, a server, and a non-transitory computer-readable storage medium in the field of communication. The method includes that: when a receiver needs to receive a microblog topic, information on a location of the receiver is acquired; the microblog topic and information on a location where the microblog topic is released are acquired from a microblog server according to a preset distance and information on the location of the receiver, wherein a distance between the location where the microblog topic is released and the location of the receiver is no greater than the preset distance; and the microblog topic is displayed in a map of an area in which the receiver is located on a

User Equipment (UE) according to the information on the location where the microblog topic is released. The system includes the UE and the microblog server. With the present disclosure, it is possible to further promote the activeness of a microblog topic.

### CLAIM OF PRIORITY

This is a continuation application of International Patent Application No.: PCT/CN2013/073735, filed on Apr. 3, 2013, which claims priority to Chinese Patent Application No.: 201210126863.4, filed on Apr. 26, 2012, the disclosure of which is incorporated by reference herein in its entirety.

### TECHNICAL FIELD

The present disclosure relates generally to the field of communication, and in particular to method, terminal, server, system and computer-readable medium for displaying a microblog topic.

### BACKGROUND

With rapid development of microblog technology, microblogs are widely used, and a microblog has become an important platform for a user to share, spread, and acquire information, a user often acquires a certain microblog topic and discusses it with another user or provides comments on the microblog topic.

A user may submit a command to a User Equipment (UE) for acquiring a microblog topic, the UE acquires microblog topics from a server, and then provides a list of acquired microblog topics, and displays the list of acquired microblog topics before the user. With such a way of displaying microblog topics, it is impossible for a user to know a microblog topic going on around a nearby area of the user, such that the activeness of a microblog topic can not be promoted further.

### SUMMARY

To further promote the activeness of a microblog topic, the present disclosure provides a method, terminal, server, system and computer-readable medium for displaying a microblog topic. A technical solution thereof is as follows.

A method for displaying a microblog topic includes:

acquiring information on a location of a receiver when the receiver needs to receive a microblog topic;

acquiring from a microblog server the microblog topic and information on a location where the microblog topic is released according to a preset distance and the information on the location of the receiver, wherein a distance between the location where the microblog topic is released and the location of the receiver is no greater than the preset distance; and

displaying, on a User Equipment UE of the receiver, the microblog topic in a map of an area in which the receiver is located according to the information on the location where the microblog topic is released.

In an embodiment, the step of acquiring information on a location of a receiver includes:

acquiring coordinates of a location of the UE, information on a cell in which the UE is located in a mobile communication network, or an address of a gateway of the mobile communication network the UE accesses; and

acquiring the information on the location of the receiver according to the coordinates of the location of the UE, information on the cell in which the UE is located in the mobile communication network, or the address of the gateway of the mobile communication network the UE accesses.

In an embodiment, the step of acquiring from a microblog server the microblog topic and information on a location where the microblog topic is released according to a preset distance and the information on the location of the receiver includes:

transmitting an acquisition request message to the microblog server, wherein the acquisition request message includes the preset distance and information on the location of the receiver, such that the microblog server acquires the microblog topic and information on the location where the microblog topic is released according to a stored corresponding relation between a microblog topic and information on the location where the microblog topic is released, the preset distance, and information on the location of the receiver; and

receiving an acquisition response message sent by the microblog server, wherein the acquisition response message includes the microblog topic and information on the location where the microblog topic is released.

In an embodiment, the step of displaying, on a User Equipment UE of the receiver, the microblog topic in a map of an area in which the receiver is located according to the information on the location where the microblog topic is released includes:

determining a location corresponding to the location where the microblog topic is released in the map of the area in which the receiver is located on the UE of the receiver according to the information on the location where the microblog topic is released; and plotting a visual graph at the location, filling the visual graph with the microblog topic, and displaying the map of the area in which the receiver is located.

In an embodiment, the method may further include:

when a releaser releases a microblog to be released, acquiring information on the location of the releaser, and sending a releasing request message to the microblog server, wherein the releasing request message includes the information on the location of the releaser and the microblog to be released, and the microblog to be released includes a microblog topic of the microblog to be released.

A method for displaying a microblog topic includes:

receiving an acquisition request message sent by a User Equipment UE when a receiver needs to receive a microblog topic, wherein the acquisition request message includes a preset distance and information on a location of the receiver;

acquiring the microblog topic and information on a location where the microblog topic is released according to a stored corresponding relation between a microblog topic and information on the location where the microblog topic is released, the preset distance, and information on the location of the receiver, the preset distance and information on the location of the receiver, wherein a distance between the location of the receiver and the location where the microblog topic is released is no greater than the preset distance; and

transmitting an acquisition response message to the UE, wherein the acquisition response message includes the microblog topic and information on the location where the microblog topic is released, such that the UE displays the microblog topic in a map of an area in which the receiver is located according to the information on the location where the microblog topic is released.

In an embodiment, the step of acquiring the microblog topic and information on a location where the microblog topic is released according to the stored corresponding relation between a microblog topic and information on the location where the microblog topic is released, the preset distance, and information on the location of the receiver, the preset distance and information on the location of the receiver includes:

calculating a distance between locations of releasing and receiving a microblog topic included in the stored corresponding relation between a microblog topic and information on the location where the microblog topic is released according to the stored corresponding relation between a microblog topic and information on the location where the microblog topic is released and information on the location of the receiver; and

acquiring a microblog topic with a distance between locations of releasing and receiving the microblog topic that is no greater than the preset distance, and acquiring information on the location where the microblog topic is released.

In an embodiment, the method may further include:

when a releaser releases a microblog to be released, receiving a releasing request message sent by a UE, wherein the releasing request message includes information on a location of the releaser and the microblog to be released; and

establishing a corresponding relation between a microblog topic of the microblog to be released and the information on the location of the releaser.

A UE includes:

a first acquisition module configured to, when a receiver needs to receive a microblog topic, acquire information on a location of the receiver;

a second acquisition module configured to acquire from a microblog server the microblog topic and information on a location where the microblog topic is released according to a preset distance and information on the location of the receiver, wherein a distance between the location where the microblog topic is released and the location of the receiver is no greater than the preset distance; and

a display module configured to display the microblog topic in a map of an area in which the receiver is located according to the information on the location where the microblog topic is released.

In an embodiment, the first acquisition module may include:

a first acquisition unit configured to acquire coordinates of a location of the UE, information on a cell in which the UE is located in a mobile communication network, or an address of a gateway of the mobile communication network the UE accesses; and

a second acquisition unit configured to acquire the information on the location of the receiver according to the coordinates of the location of the UE, information on the cell in which the UE is located in the mobile communication network, or the address of the gateway of the mobile communication network the UE accesses.

In an embodiment, the second acquisition module may include:

a sending unit configured to send an acquisition request message the microblog server, wherein the acquisition request message includes the preset distance and information on the location of the receiver, such that the microblog server acquires the microblog topic and information on the location where the microblog topic is released according to a stored corresponding relation between a microblog topic and information on the location where the microblog topic is released, the preset distance, and information on the location of the receiver; and

a receiving unit configured to receive an acquisition response message sent by the microblog server, wherein the acquisition response message includes the microblog topic and information on the location where the microblog topic is released.

In an embodiment, the display module may include:

a determination unit configured to determine a location corresponding to the location where the microblog topic is released in the map of the area in which the receiver is located according to the information on the location where the microblog topic is released; and

a display unit configured to plot a visual graph at the location, fill the visual graph with the microblog topic, and display the map of the area in which the receiver is located.

In an embodiment, the UE may further include:

a releasing module configured to, when a releaser releases a microblog to be released, acquire information on the location of the releaser, and send a releasing request message to the microblog server, wherein the releasing request message includes the information on the location of the releaser and the microblog to be released, and the microblog to be released includes a microblog topic of the microblog to be released.

A microblog server includes:

a first receiving module configured to, when a receiver needs to receive a microblog topic, receive an acquisition request message sent by a User Equipment (UE), wherein the acquisition request message includes a preset distance and information on a location of the receiver;

a third acquisition module configured to acquire the microblog topic and information on a location where the microblog topic is released according to a stored corresponding relation between a microblog topic and information on the location where the microblog topic is released, the preset distance, and information on the location of the receiver, the preset distance and information on the location of the receiver, wherein a distance between the location of the receiver and the location where the microblog topic is released is no greater than the preset distance; and

a sending module configured to send an acquisition response message to the UE, wherein the acquisition response message includes the microblog topic and information on the location where the microblog topic is released, such that the UE displays the microblog topic in a map of an area in which the receiver is located according to the information on the location where the microblog topic is released.

In an embodiment, the third acquisition module may include:

a calculation unit configured to calculate a distance between locations of releasing and receiving a microblog topic included in the stored corresponding relation between a microblog topic and information on the location where the microblog topic is released according to the stored corresponding relation between a microblog topic and information on the location where the microblog topic is released and information on the location of the receiver; and

a third acquisition unit configured to acquire a microblog topic with a distance between locations of releasing and receiving the microblog topic that is no greater than the preset distance, and acquire information on the location where the microblog topic is released.

In an embodiment, the server may further include:

a second receiving module configured to, when a releaser releases a microblog to be released, receive a releasing request message sent by a UE, wherein the releasing request message includes information on a location of the releaser and the microblog to be released; and

an establishing module configured to establish a corresponding relation between a microblog topic of the microblog to be released and the information on the location of the releaser.

One or more non-transitory computer-readable medium include computer-executable instructions for executing a method for displaying a microblog topic, the method including:

when a receiver needs to receive a microblog topic, acquiring information on a location of the receiver;

acquiring from a microblog server the microblog topic and information on a location where the microblog topic is released according to a preset distance and information on the location of the receiver, wherein a distance between the location where the microblog topic is released and the location of the receiver is no greater than the preset distance; and

displaying the microblog topic in a map of an area in which the receiver is located on a User Equipment (UE) of the receiver according to the information on the location where the microblog topic is released.

One or more non-transitory computer-readable medium include computer-executable instructions for executing a method for displaying a microblog topic, the method including:

when a receiver needs to receive a microblog topic, receiving an acquisition request message sent by a User Equipment (UE), wherein the acquisition request message includes a preset distance and information on a location of the receiver;

acquiring the microblog topic and information on a location where the microblog topic is released according to a stored corresponding relation between a microblog topic and information on the location where the microblog topic is released, the preset distance, and information on the location of the receiver, the preset distance and information on the location of the receiver, wherein a distance between the location of the receiver and the location where the microblog topic is released is no greater than the preset distance; and

sending an acquisition response message to the UE, wherein the acquisition response message includes the microblog topic and information on the location where the microblog topic is released, such that the UE displays the microblog topic in a map of an area in which the receiver is located according to the information on the location where the microblog topic is released.

A system for displaying a microblog topic includes a UE and a microblog server as mentioned before.

In an embodiment of the present disclosure, information on a location of a receiver is acquired, a microblog topic and information on a location where the microblog topic is released are acquired from a microblog server according to a preset distance and information on the location of the receiver, wherein a distance between the location where the microblog topic is released and the location of the receiver is no greater than the preset distance, and the microblog topic is displayed in the map of the area in which the receiver is located according to information on the location where the microblog topic is released. Wherein, a microblog topic is displayed on the map of the area in which the receiver is located if the distance between locations of releasing and receiving the microblog topic is no greater than the preset distance, thereby allowing a user to know a microblog topic going on around a nearby area of the user, and further promoting the activeness of a microblog topic.

### BRIEF DESCRIPTION OF THE DRAWINGS

FIG. 1 is a flowchart of a method for displaying a microblog topic provided by one embodiment of the present disclosure;

FIG. 2 is a flowchart of a method for displaying a microblog topic provided by another embodiment of the present disclosure;

FIG. 3 is a flowchart of a method for displaying a microblog topic provided by yet another embodiment of the present disclosure;

FIG. 4 is a schematic diagram of a UE provided by one embodiment of the present disclosure;

FIG. 5 is a schematic diagram of a structure of a microblog server provided by another embodiment of the present disclosure; and

FIG. 6 is a schematic diagram of a structure of a system for displaying a microblog topic provided by yet another embodiment of the present disclosure.

### DETAILED DESCRIPTION

To clearly show technical problems to be solved, technical solutions, and advantages of the present disclosure, the present disclosure is further described below with reference to the drawings and embodiments.

### Embodiment 1

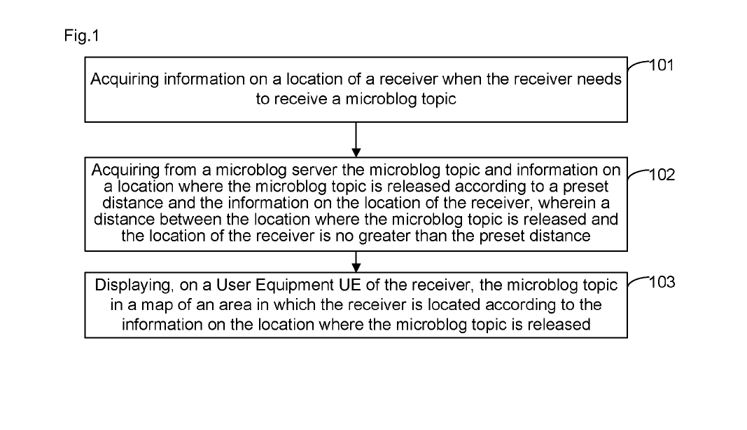

As shown in FIG. 1, the present disclosure provides a method for displaying a microblog topic, including:

step 101: when a receiver needs to receive a microblog topic, information on a location of the receiver is acquired;

step 102: the microblog topic and information on a location where the microblog topic is released are acquired from a microblog server according to a preset distance and information on the location of the receiver, wherein a distance between the location where the microblog topic is released and the location of the receiver is no greater than the preset distance; and

step 103: the microblog topic is displayed in a map of an area in which the receiver is located on a UE of the receiver according to the information on the location where the microblog topic is released.

In one embodiment of the present disclosure, information on a location of the receiver is acquired, the microblog topic and information on a location where the microblog topic is released are acquired from a microblog server according to a preset distance and information on the location of the receiver, wherein a distance between the location where the microblog topic is released and the location of the receiver is no greater than the preset distance, the microblog topic is displayed in a map of an area in which the receiver is located on a UE of the receiver according to the information on the location where the microblog topic is released. The UE may be a handheld smartphone, a palmtop, a Personal Digital Assistant (PDA), or the like. A microblog topic is displayed on the map of the area in which the receiver is located if the distance between locations of releasing and receiving the microblog topic is no greater than the preset distance, thereby allowing a user to know a microblog topic going on around a nearby area of the user, and further promoting the activeness of a microblog topic.

### Embodiment 2

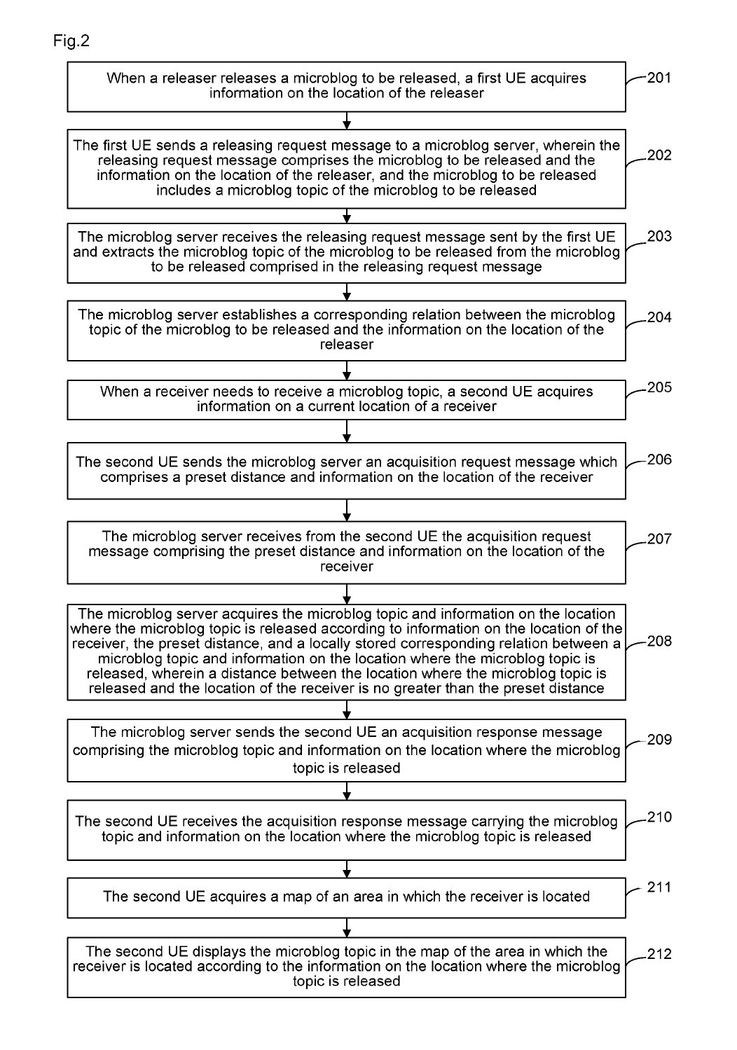

As shown in FIG. 2, an embodiment of the present disclosure provides a method for displaying a microblog topic.

when a releaser releases a microblog to be released using a first UE, the first UE may release the microblog to be released through steps 201 to 205 as follows.

Step 201: when a releaser releases a microblog to be released, a first UE acquires information on the location of the releaser;

Specifically, the first UE may acquire information on the location of the releaser through methods as follows.

Firstly, the first UE may perform positioning through a local Global Positioning System (GPS) module to obtain coordinates of the present location of the first UE, and take the coordinates of the present location of the first UE as information on the location of the releaser.

Secondly, the first UE may acquire information on a cell in which the UE is located in a mobile communication network, and acquire information on the present location of the releaser according to the information on the cell in which the UE is located in the mobile communication network, wherein the information on the location of the releaser may be the coordinates of the location of the releaser.

The first UE may acquire the coordinates of the location of the first UE from a corresponding relation between information on a cell and coordinates of a location stored in a location server according to the information on the cell in which the UE is located in the mobile communication network, and determine the coordinates of the location of the first UE as the information on the location of the releaser.

Thirdly, the first UE may acquire an address of a gateway of the mobile communication network the UE accesses, and acquire information on the location of the releaser according to the address of the gateway of the mobile communication network the UE accesses, wherein the information on the location of the releaser may be the coordinates of the location of the releaser.

The first UE may acquire the coordinates of the location of the first UE from a corresponding relation between an address of a gateway and coordinates of a location stored in the location server according to the address of the gateway of the mobile communication network the UE accesses, and determine the coordinates of the location of the first UE as the information on the location of the releaser.

Information on a cell in the mobile communication network may be identifier information of the cell or identifier information of a base station of the cell in the mobile communication network. The coordinates of the location of the first UE may be the longitude and latitude of the present location of the first UE and the like.

The address of the gateway may be an Internet Protocol (IP) address, a Media Access Control (MAC) address of the gateway, or the like.

The releaser may submit to the first UE the microblog to be released including a microblog topic, microblog content, and the like; then the releaser submits to the first UE a releasing command, such that the first UE starts to release the microblog to be released.

Step 202: the first UE sends a releasing request message to a microblog server, wherein the releasing request message includes the microblog to be released and the information on the location of the releaser, and the microblog to be released includes a microblog topic of the microblog to be released;

Step 203: the microblog server receives the releasing request message sent by the first UE and extracts the microblog topic of the microblog to be released from the microblog to be released carried by the releasing request message;

Step 204: the microblog server establishes a corresponding relation between the microblog topic of the microblog to be released and the information on the location of the releaser;

Specifically, the microblog server takes a microblog topic of the microblog to be released and information on the location where the microblog topic is released as a record, and stores the record in a corresponding relation between a microblog topic and information on the location where the microblog topic is released.

The microblog server further stores the microblog to be released in a microblog list, so as to release the microblog to be released.

When a receiver acquires a microblog topic through a second UE, the second UE may receive a microblog topic going on near the receiver through steps 205 to 212 as follows.

Step 205: when a receiver needs to receive a microblog topic, a second UE acquires information on a current location of a receiver;

Specifically, the second UE may acquire information on the location of the receiver through methods as follows.

Firstly, the second UE may perform positioning through a local GPS module to obtain coordinates of the present location of the second UE, and take the coordinates of the present location of the second UE as the information on the location of the receiver.

Secondly, the second UE may acquire information on a cell in which the UE is located in a mobile communication network, and acquire information on the present location of the receiver according to the information on the cell in which the UE is located in the mobile communication network.

The second UE may acquire the coordinates of the location of the second UE from a corresponding relation between information on a cell and coordinates of a location stored in a location server according to the information on the cell in which the UE is located in the mobile communication network, and determine the coordinates of the location of the second UE as the information on the location of the receiver.

Thirdly, the second UE may acquire an address of a gateway of the mobile communication network the UE accesses, and acquire information on the location of the receiver according to the address of the gateway of the mobile communication network the UE accesses.

The second UE may acquire the coordinates of the location of the second UE from a corresponding relation between an address of a gateway and coordinates of a location stored in a location server according to the address of the gateway of the mobile communication network the UE accesses, and determine the coordinates of the location of the second UE as the information on the location of the receiver.

Step 206: the second UE sends an acquisition request message to the microblog server, wherein the acquisition request message includes a preset distance and information on the location of the receiver;

The preset distance is stored in the second UE beforehand, and correspondingly, the second UE may directly acquire the locally stored preset distance; or, the receiver may provide the second UE with the preset distance, and correspondingly, the second UE may receive the preset distance provided by the receiver, then the second UE may send the microblog server the acquisition request message including the acquired preset distance and information on the location of the receiver.

Step 207: the microblog server receives from the second UE the acquisition request message including the preset distance and information on the location of the receiver;

Step 208: the microblog server acquires the microblog topic and information on the location where the microblog topic is released according to information on the location of the receiver, the preset distance, and a locally stored corresponding relation between a microblog topic and information on the location where the microblog topic is released, wherein a distance between the location where the microblog topic is released and the location of the receiver is no greater than the preset distance;

Specifically, an area is determined by taking a point corresponding to the information on the location of the receiver as a centre and taking the preset distance as a radius, and a microblog topic released in the area and information on the location where the microblog topic is released are acquired from a stored corresponding relation between a microblog topic and information on a location where a microblog topic is released; or

Scanning is performed on a record starting from a first record in the stored corresponding relation between a microblog topic and information on a location where a microblog topic is released, wherein the scanned record includes a microblog topic and information on the location where the microblog topic is released; a distance between locations of releasing and receiving the microblog topic is calculated according to information on the location of the receiver and information on the location where the microblog topic is released; a distance between locations of releasing and receiving each microblog topic included in the stored corresponding relation between a microblog topic and information on a location where a microblog topic is released is calculated as described above, then a microblog topic with a distance between locations of releasing and receiving the microblog topic that is no greater than the preset distance and information on the location where the microblog topic is released are selected from the stored corresponding relation between a microblog topic and information on a location where a microblog topic is released.

Step 209: the microblog server sends the second UE an acquisition response message carrying the microblog topic and information on the location where the microblog topic is released;

Furthermore, the microblog server may further determine a map of an area in which the receiver is located according to information on the location of the receiver, and correspondingly, the acquisition response message sent to the second UE by the microblog server not only includes the microblog topic and information on the location where the microblog topic is released, but also includes the map of the area in which the receiver is located.

Step 210: the second UE receives the acquisition response message carrying the microblog topic and information on the location where the microblog topic is released;

Step 211: the second UE acquires a map of an area in which the receiver is located;

Specifically, if the acquisition response message includes the map of the location of the receiver, then the second UE extracts the map of the area in which the receiver is located directly from the acquisition response message; or

if the second UE has a pre-stored map of the area in which the receiver is located, then the second UE acquires the pre-stored map of the area in which the receiver is located; or

the second UE sends a map request message carrying information on the location of the receiver to a map server, which receives the map request message, determines the area in which the receiver is located according to information on the location of the receiver, acquires the map of the area in which the receiver is located, and sends the map of the area in which the receiver is located to the second UE, which receives the map of the area in which the receiver is located.

Step 212: the second UE displays the microblog topic in the map of the area in which the receiver is located according to the information on the location where the microblog topic is released.

Specifically, the second UE determines a location corresponding to the location where the microblog topic is released in the map of the area in which the receiver is located according to the information on the location where the microblog topic is released, plots a visual graph at the determined location, fills the plotted visual graph with the microblog topic, and displays the map of the area in which the receiver is located.

In an embodiment of the present disclosure, a UE acquires information on the location of a receiver, send an acquisition request message to a location server including a preset distance and information on the location of the receiver; a microblog server acquires a microblog topic and information on the location where the microblog topic is released according to a stored corresponding relation between a microblog topic and information on the location where the microblog topic is released, information on the location of the receiver, and the preset distance, wherein the distance between locations of releasing and receiving the microblog topic is no greater than the preset distance; then the UE displays the microblog topic in the map of the area in which the receiver is located according to information on the location where the microblog topic is released. Wherein a microblog topic with a distance between locations of releasing and receiving the microblog topic that is no greater than the preset distance is displayed on the map of the area in which the receiver is located, thereby allowing a user to know a microblog topic going on around a nearby area of the user, and further promoting the activeness of a microblog topic.

### Embodiment 3

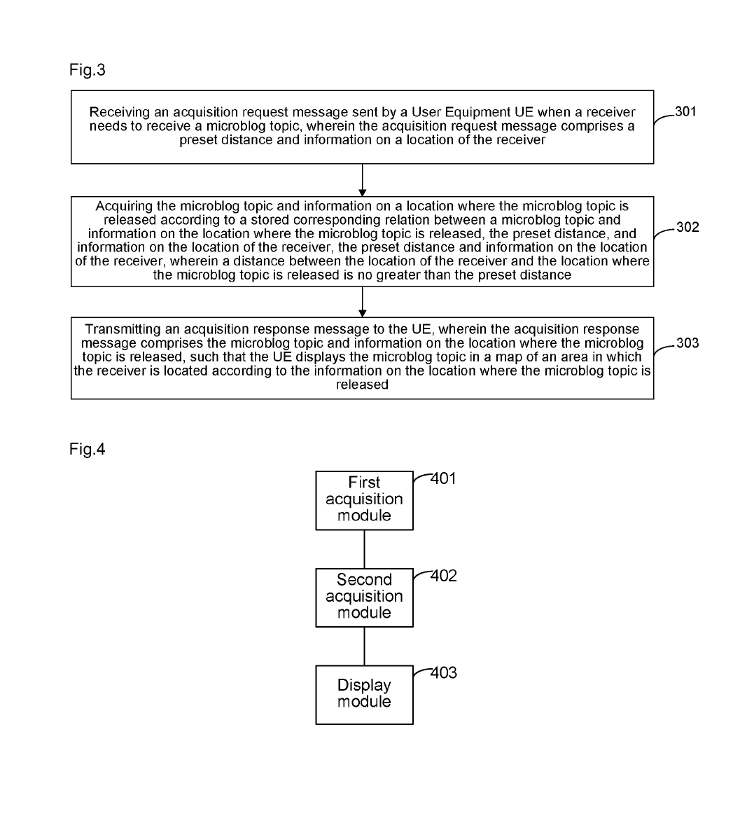

As shown in FIG. 3, an embodiment of the present disclosure provides a method for displaying a microblog topic, the method including that:

Step 301: when a receiver needs to receive a microblog topic, an acquisition request message is received from a UE, wherein the acquisition request message includes a preset distance and information on a location of the receiver;

Step 302: the microblog topic and information on a location where the microblog topic is released are acquired according to a stored corresponding relation between a microblog topic and information on the location where the microblog topic is released, the preset distance, and information on the location of the receiver, the preset distance and information on the location of the receiver, wherein a distance between the location of the receiver and the location where the microblog topic is released is no greater than the preset distance; and

Step 303: an acquisition response message is transmitted to the UE, wherein the acquisition response message includes the microblog topic and information on the location where the microblog topic is released, such that the UE displays the microblog topic in a map of an area in which the receiver is located according to the information on the location where the microblog topic is released.

Wherein, an executor of the embodiment may be a microblog server.

In an embodiment of the present disclosure, a microblog topic and information on the location where the microblog topic is released are acquired according to a stored corresponding relation between a microblog topic and information on a location, information on the location of the receiver, and the preset distance, wherein the distance between locations of releasing and receiving the microblog topic is no greater than the preset distance, such that the UE displays the microblog topic in the map of the area in which the receiver is located according to information on the location where the microblog topic is released. A microblog topic released by a releaser is displayed on the map of the area in which the receiver is located if the distance between locations of the releaser and the receiver is no greater than the preset distance, thereby allowing a user to know a microblog topic going on around a nearby area of the user, and further promoting the activeness of a microblog topic.

### Embodiment 4

As shown in FIG. 4, an embodiment of the present disclosure provides a UE, including

a first acquisition module 401 configured to, when a receiver needs to receive a microblog topic, acquire information on a location of the receiver;

a second acquisition module 402 configured to acquire from a microblog server the microblog topic and information on a location where the microblog topic is released according to a preset distance and information on the location of the receiver, wherein a distance between the location where the microblog topic is released and the location of the receiver is no greater than the preset distance; and

a display module 403 configured to display the microblog topic in a map of an area in which the receiver is located on a UE of the receiver according to the information on the location where the microblog topic is released.

Wherein, the first acquisition module 401 includes:

a first acquisition unit configured to acquire coordinates of a location of the UE, information on a cell in which the UE is located in a mobile communication network, or an address of a gateway of the mobile communication network the UE accesses; and

a second acquisition unit configured to acquire the information on the location of the receiver according to the coordinates of the location of the UE, information on the cell in which the UE is located in the mobile communication network, or the address of the gateway of the mobile communication network the UE accesses.

Wherein, the second acquisition module 402 includes:

a sending unit configured to send an acquisition request message the microblog server, wherein the acquisition request message includes the preset distance and information on the location of the receiver, such that the microblog server acquires the microblog topic and information on the location where the microblog topic is released according to a stored corresponding relation between a microblog topic and information on the location where the microblog topic is released, the preset distance, and information on the location of the receiver; and

a receiving unit configured to receive an acquisition response message sent by the microblog server, wherein the acquisition response message includes the microblog topic and information on the location where the microblog topic is released.

Wherein, the display module 403 includes:

a determination unit configured to determine a location corresponding to the location where the microblog topic is released in the map of the area in which the receiver is located according to the information on the location where the microblog topic is released; and

a display unit configured to plot a visual graph at the location, fill the visual graph with the microblog topic, and display the map of the area in which the receiver is located.

The UE further includes

a releasing module configured to, when a releaser releases a microblog to be released, acquire information on the location of the releaser, and send a releasing request message to the microblog server, wherein the releasing request message includes the information on the location of the releaser and the microblog to be released, and the microblog to be released includes a microblog topic of the microblog to be released.

In an embodiment of the present disclosure, information on the location of a receiver is acquired, the microblog topic and information on a location where the microblog topic is released are acquired from a microblog server according to a preset distance and information on the location of the receiver, wherein the distance between locations of releasing and receiving the microblog topic is no greater than the preset distance; the microblog topic is displayed in the map of the area in which the receiver is located according to information on the location where the microblog topic is released. Wherein, a microblog topic released by a releaser is displayed on the map of the area in which the receiver is located if the distance between locations of the releaser and the receiver is no greater than the preset distance, thereby allowing a user to know a microblog topic going on around a nearby area of the user, and further promoting the activeness of a microblog topic.

### Embodiment 5

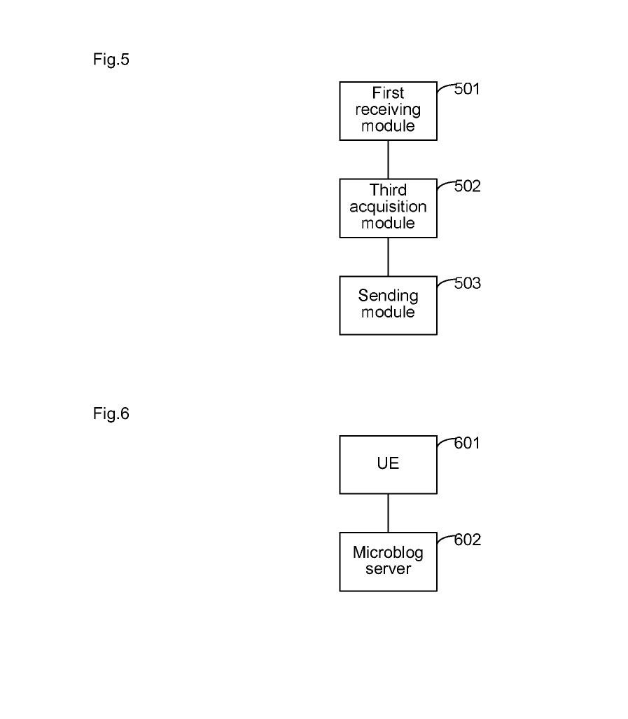

As shown in FIG. 5, an embodiment of the present disclosure provides a microblog server, including:

a first receiving module 501 configured to, when a receiver needs to receive a microblog topic, receive an acquisition request message sent by a User Equipment (UE), wherein the acquisition request message includes a preset distance and information on a location of the receiver;

a third acquisition module 502 configured to acquire the microblog topic and information on a location where the microblog topic is released according to a stored corresponding relation between a microblog topic and information on the location where the microblog topic is released, the preset distance, and information on the location of the receiver, the preset distance and information on the location of the receiver, wherein a distance between the location of the receiver and the location where the microblog topic is released is no greater than the preset distance; and

a sending module 503 configured to send an acquisition response message to the UE, wherein the acquisition response message includes the microblog topic and information on the location where the microblog topic is released, such that the UE displays the microblog topic in a map of an area in which the receiver is located according to the information on the location where the microblog topic is released.

Wherein the third acquisition module 502 includes:

a calculation unit configured to calculate a distance between locations of releasing and receiving a microblog topic included in the stored corresponding relation between a microblog topic and information on the location where the microblog topic is released according to the stored corresponding relation between a microblog topic and information on the location where the microblog topic is released and information on the location of the receiver; and

a third acquisition unit configured to acquire a microblog topic with a distance between locations of releasing and receiving the microblog topic that is no greater than the preset distance, and acquire information on the location where the microblog topic is released.

The server further includes:

a second receiving module configured to, when a releaser releases a microblog to be released, receive a releasing request message sent by a UE, wherein the releasing request message includes information on a location of the releaser and the microblog to be released; and

an establishing module configured to establish a corresponding relation between a microblog topic of the microblog to be released and the information on the location of the releaser.

In an embodiment of the present disclosure, a microblog topic and information on the location where the microblog topic is released are acquired according to a stored corresponding relation between a microblog topic and information on a location, information on the location of a receiver, and a preset distance, wherein the distance between locations of releasing and receiving the microblog topic is no greater than the preset distance, such that the UE displays the microblog topic in the map of the area in which the receiver is located according to information on the location where the microblog topic is released. Wherein a microblog topic released by a releaser is displayed on the map of the area in which the receiver is located if the distance between locations of the releaser and the receiver is no greater than the preset distance, thereby allowing a user to know a microblog topic going on around a nearby area of the user, and further promoting the activeness of a microblog topic.

### Embodiment 6

As shown in FIG. 6, an embodiment of the present disclosure provides a system for displaying a microblog topic, including a UE 601 according to Embodiment 4 and a microblog server 602 according to Embodiment 5.

Those skilled in the art may understand that all or part of the steps of the embodiments may be implemented through a hardware or may be completed by instructing a related hardware through a program, which program may be stored in a non-transitory computer-readable storage medium, the non-transitory computer-readable storage medium may be a Read-Only Memory, a magnetic disk, a CD, and the like.

What described are merely preferred embodiments of the disclosure, and are not intended to limit the scope of the present disclosure. Any modification, equivalent replacement, improvement, and the like made within the spirit and principle of the present disclosure should be included in the scope of the present disclosure.

1. A method for displaying a microblog topic, comprising:
acquiring information on a location of a receiver when the receiver needs to receive a microblog topic;
acquiring from a microblog server the microblog topic and information on a location where the microblog topic is released according to a preset distance and the information on the location of the receiver, wherein a distance between the location where the microblog topic is released and the location of the receiver is no greater than the preset distance; and
displaying, on a User Equipment UE of the receiver, the microblog topic in a map of an area in which the receiver is located according to the information on the location where the microblog topic is released.

2. The method according to claim 1, wherein the step of acquiring information on a location of a receiver comprises:
acquiring coordinates of a location of the UE, information on a cell in which the UE is located in a mobile communication network, or an address of a gateway of the mobile communication network the UE accesses; and
acquiring the information on the location of the receiver according to the coordinates of the location of the UE, information on the cell in which the UE is located in the mobile communication network, or the address of the gateway of the mobile communication network the UE accesses.

3. The method according to claim 1, wherein the step of acquiring from a microblog server the microblog topic and information on a location where the microblog topic is released according to a preset distance and the information on the location of the receiver comprises:
transmitting an acquisition request message to the microblog server, wherein the acquisition request message comprises the preset distance and information on the location of the receiver, such that the microblog server acquires the microblog topic and information on the location where the microblog topic is released according to a stored corresponding relation between a microblog topic and information on the location where the microblog topic is released, the preset distance, and information on the location of the receiver; and
receiving an acquisition response message sent by the microblog server, wherein the acquisition response message comprises the microblog topic and information on the location where the microblog topic is released.

4. The method according to claim 1, wherein the step of displaying, on a User Equipment UE of the receiver, the microblog topic in a map of an area in which the receiver is located according to the information on the location where the microblog topic is released comprises:
determining a location corresponding to the location where the microblog topic is released in the map of the area in which the receiver is located on the UE of the receiver according to the information on the location where the microblog topic is released; and
plotting a visual graph at the location, filling the visual graph with the microblog topic, and displaying the map of the area in which the receiver is located.

5. A method for displaying a microblog topic, comprising:
receiving an acquisition request message sent by a User Equipment UE when a receiver needs to receive a microblog topic, wherein the acquisition request message comprises a preset distance and information on a location of the receiver;
acquiring the microblog topic and information on a location where the microblog topic is released according to a stored corresponding relation between a microblog topic and information on the location where the microblog topic is released, the preset distance, and information on the location of the receiver, the preset distance and information on the location of the receiver, wherein a distance between the location of the receiver and the location where the microblog topic is released is no greater than the preset distance; and
transmitting an acquisition response message to the UE, wherein the acquisition response message comprises the microblog topic and information on the location where the microblog topic is released, such that the UE displays the microblog topic in a map of an area in which the receiver is located according to the information on the location where the microblog topic is released.

6. The method according to claim 5, wherein the step of acquiring the microblog topic and information on a location where the microblog topic is released according to the stored corresponding relation between a microblog topic and information on the location where the microblog topic is released, the preset distance, and information on the location of the receiver, the preset distance and information on the location of the receiver comprises:
calculating a distance between locations of releasing and receiving a microblog topic comprised in the stored corresponding relation between a microblog topic and information on the location where the microblog topic is released according to the stored corresponding relation between a microblog topic and information on the location where the microblog topic is released and information on the location of the receiver; and
acquiring a microblog topic with a distance between locations of releasing and receiving the microblog topic that is no greater than the preset distance, and acquiring information on the location where the microblog topic is released.

7. A user equipment, comprising:
a first acquisition module configured to, when a receiver needs to receive a microblog topic, acquire information on a location of the receiver;
a second acquisition module configured to acquire from a microblog server the microblog topic and information on a location where the microblog topic is released according to a preset distance and information on the location of the receiver, wherein a distance between the location where the microblog topic is released and the location of the receiver is no greater than the preset distance; and
a display module configured to display the microblog topic in a map of an area in which the receiver is located according to the information on the location where the microblog topic is released.

8. The user equipment according to claim 7, wherein the second acquisition module comprises:
a sending unit configured to send an acquisition request message the microblog server, wherein the acquisition request message comprises the preset distance and information on the location of the receiver, such that the microblog server acquires the microblog topic and information on the location where the microblog topic is released according to a stored corresponding relation between a microblog topic and information on the location where the microblog topic is released, the preset distance, and information on the location of the receiver; and
a receiving unit configured to receive an acquisition response message sent by the microblog server, wherein the acquisition response message comprises the microblog topic and information on the location where the microblog topic is released.

9. The user equipment according to claim 7, wherein the display module comprises:
a determination unit configured to determine a location corresponding to the location where the microblog topic is released in the map of the area in which the receiver is located according to the information on the location where the microblog topic is released; and
a display unit configured to plot a visual graph at the location, fill the visual graph with the microblog topic, and display the map of the area in which the receiver is located.

10. The user equipment according to claim 7, further comprising:
a releasing module configured to, when a releaser releases a microblog to be released, acquire information on the location of the releaser, and send a releasing request message to the microblog server, wherein the releasing request message comprises the information on the location of the releaser and the microblog to be released, and the microblog to be released comprises a microblog topic of the microblog to be released.

11. A microblog server, comprising:
a first receiving module configured to, when a receiver needs to receive a microblog topic, receive an acquisition request message sent by a User Equipment (UE), wherein the acquisition request message comprises a preset distance and information on a location of the receiver;
a third acquisition module configured to acquire the microblog topic and information on a location where the microblog topic is released according to a stored corresponding relation between a microblog topic and information on the location where the microblog topic is released, the preset distance, and information on the location of the receiver, the preset distance and information on the location of the receiver, wherein a distance between the location of the receiver and the location where the microblog topic is released is no greater than the preset distance; and
a sending module configured to send an acquisition response message to the UE, wherein the acquisition response message comprises the microblog topic and information on the location where the microblog topic is released, such that the UE displays the microblog topic in a map of an area in which the receiver is located according to the information on the location where the microblog topic is released.

12. The server according to claim 11, wherein the third acquisition module comprises:
a calculation unit configured to calculate a distance between locations of releasing and receiving a microblog topic comprised in the stored corresponding relation between a microblog topic and information on the location where the microblog topic is released according to the stored corresponding relation between a microblog topic and information on the location where the microblog topic is released and information on the location of the receiver; and
a third acquisition unit configured to acquire a microblog topic with a distance between locations of releasing and receiving the microblog topic that is no greater than the preset distance, and acquire information on the location where the microblog topic is released.

13. The server according to claim 11, further comprising:
a second receiving module configured to, when a releaser releases a microblog to be released, receive a releasing request message sent by a UE, wherein the releasing request message comprises information on a location of the releaser and the microblog to be released; and
an establishing module configured to establish a corresponding relation between a microblog topic of the microblog to be released and the information on the location of the releaser.

14. One or more non-transitory computer-readable medium comprising computer-executable instructions, the computer-executable instructions are executed for implementing the following steps:
acquiring information on a location of a receiver when the receiver needs to receive a microblog topic;
acquiring from a microblog server the microblog topic and information on a location where the microblog topic is released according to a preset distance and the information on the location of the receiver, wherein a distance between the location where the microblog topic is released and the location of the receiver is no greater than the preset distance; and
displaying, on a User Equipment UE of the receiver, the microblog topic in a map of an area in which the receiver is located according to the information on the location where the microblog topic is released.

15. The non-transitory computer-readable medium according to claim 14, wherein the step of acquiring information on a location of a receiver comprises:
acquiring coordinates of a location of the UE, information on a cell in which the UE is located in a mobile communication network, or an address of a gateway of the mobile communication network the UE accesses; and
acquiring the information on the location of the receiver according to the coordinates of the location of the UE, information on the cell in which the UE is located in the mobile communication network, or the address of the gateway of the mobile communication network the UE accesses.

16. The non-transitory computer-readable medium according to claim 14, wherein the step of acquiring from a microblog server the microblog topic and information on a location where the microblog topic is released according to a preset distance and the information on the location of the receiver comprises:
transmitting an acquisition request message to the microblog server, wherein the acquisition request message comprises the preset distance and information on the location of the receiver, such that the microblog server acquires the microblog topic and information on the location where the microblog topic is released according to a stored corresponding relation between a microblog topic and information on the location where the microblog topic is released, the preset distance, and information on the location of the receiver; and
receiving an acquisition response message sent by the microblog server, wherein the acquisition response message comprises the microblog topic and information on the location where the microblog topic is released.

17. The non-transitory computer-readable medium according to claim 14, wherein the step of displaying, on a User Equipment UE of the receiver, the microblog topic in a map of an area in which the receiver is located according to the information on the location where the microblog topic is released comprises:
determining a location corresponding to the location where the microblog topic is released in the map of the area in which the receiver is located on the UE of the receiver according to the information on the location where the microblog topic is released; and
plotting a visual graph at the location, filling the visual graph with the microblog topic, and displaying the map of the area in which the receiver is located.

18. The non-transitory computer-readable medium according to claim 14, further comprising:
when a releaser releases a microblog to be released, acquiring information on the location of the releaser, and sending a releasing request message to the microblog server, wherein the releasing request message comprises the information on the location of the releaser and the microblog to be released, and the microblog to be released comprises a microblog topic of the microblog to be released.

19. One or more non-transitory computer-readable medium comprising computer-executable instructions, the computer-executable instructions are executed for implementing the following steps:
receiving an acquisition request message sent by a User Equipment UE when a receiver needs to receive a microblog topic, wherein the acquisition request message comprises a preset distance and information on a location of the receiver;
acquiring the microblog topic and information on a location where the microblog topic is released according to a stored corresponding relation between a microblog topic and information on the location where the microblog topic is released, the preset distance, and information on the location of the receiver, the preset distance and information on the location of the receiver, wherein a distance between the location of the receiver and the location where the microblog topic is released is no greater than the preset distance; and
transmitting an acquisition response message to the UE, wherein the acquisition response message comprises the microblog topic and information on the location where the microblog topic is released, such that the UE displays the microblog topic in a map of an area in which the receiver is located according to the information on the location where the microblog topic is released.

20. The non-transitory computer-readable medium according to claim 19, wherein the step of acquiring the microblog topic and information on a location where the microblog topic is released according to the stored corresponding relation between a microblog topic and information on the location where the microblog topic is released, the preset distance, and information on the location of the receiver, the preset distance and information on the location of the receiver comprises:
calculating a distance between locations of releasing and receiving a microblog topic comprised in the stored corresponding relation between a microblog topic and information on the location where the microblog topic is released according to the stored corresponding relation between a microblog topic and information on the location where the microblog topic is released and information on the location of the receiver; and
acquiring a microblog topic with a distance between locations of releasing and receiving the microblog topic that is no greater than the preset distance, and acquiring information on the location where the microblog topic is released.
